(19) United States
(12) Patent Application Publication
(10) Pub. No.: US 2006/0146707 A1
(43) Pub. Date: Jul. 6, 2006

(54) Device for processing traffic data to optimize control of quality of service in a communications network

(75) Inventors: Alain Brethereau, Viroflay (FR); Jean-Roch Houllier, Saint-Michel sur Orge (FR); Eric Brigant, Velizy-Villacoublay (FR); Beatrix De Mathan, Paris (FR); Antoine Landrault, Rambouillet (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/319,538

(22) Filed: Dec. 29, 2005

(30) Foreign Application Priority Data
Dec. 31, 2004 (FR) 0453273

(51) Int. Cl. H04L 12/26

(52) U.S. Cl. 370/230; 370/252

(57) ABSTRACT

A device (D) is dedicated to processing traffic data for a system (OO) for optimizing a communications network including network elements (Ci) through which passes traffic defined locally by parameter values. The device (D) comprises processor means (MT) arranged: firstly to determine for selected elements of said network a traffic model from successive measured values of a parameter representative of said traffic; and secondly to compare the traffic models determined in this way to base traffic models each representative of one type of traffic so as to associate a base traffic model with one of said network elements when a measured traffic model that corresponds to it is comparable to said base traffic model.

The invention relates to communications networks and more particularly to optimizing the control of quality of service (QoS) in such networks.

The costs of deploying and operating communications networks oblige their operators to optimize the use of their communications resources to assure a balance between their profits and the quality of service enjoyed by their customers. This is especially true of mobile and cellular radio networks.

The person skilled in the art knows that managing network parameters to control the use of the resources of a network is a difficult and complex task and, moreover, one that is ongoing in the event of expansion and/or densification of the network. It necessitates the use of a network optimization system (or tool) for example the RNO® Radio Network Optimization tool developed by ALCATEL for cellular radio networks. That kind of system is used to control quality of service in certain elements of the network, for example cells thereof, to analyze the causes of quality of service problems, and to propose solutions to those problems.

The RNO® system defines groups of cells as a function of certain criteria, for example their belonging to a given geographical area, in order to track and study quality of service within at least some of those groups. Because the criteria for defining groups of cells are based on logical parameters or indicators, they can be used only to manage a portion of the parameters involved in the use of resources. For example, it is not possible to take account of the impact of the behavior of users.

What is more, optimization based only on the concept of groups of cells cannot be comprehensive, in particular because other types of network elements and concepts are involved in controlling the use of resources (for example handover (intercellular transfer) of calls).

Thus an object of the invention is to improve on this situation, in particular in radio communications networks.

To this end the invention proposes a device for processing traffic data for a system for optimizing a communications network including network elements through which passes traffic defined locally by parameter values.

The processor device is characterized in that it comprises processor means arranged: firstly to determine for selected elements of said network a traffic model from successive measured values of a parameter representative of said traffic; and secondly to compare the traffic models determined in this way to base traffic models each representative of one type of traffic so as to associate a base traffic model with one of said network elements when a measured traffic model that corresponds to it is comparable to said base traffic model.

In the present context, the expression “traffic model” refers to any model representing the evolution of voice and/or data traffic in terms of telecommunications volume and/or relating to the manner in which a call associated with traffic progresses, for example the call duration.

The processor device of the invention may have other features and in particular, separately or in combination:

its processor means may define sets of objects (object zones) each grouping (physical and/or logical) network elements associated with a common base traffic model;

the sets of objects may be selected from groups of network elements and movement groups;

its processor means may effect said comparison by means of a proximity criterion;

its processor means may determine said traffic models from successive values of a parameter representative of said traffic as a function of selected dates and selected times on those dates; at least certain of said traffic models may be determined in a two-dimensional form or in a three-dimensional form;

analysis means which firstly collect traffic models associated with at least certain of said network elements and obtained periodically (with a first selected period) so as to have periodically (with a second period that is a multiple of the first period) a first set of traffic models for each of those network elements and secondly analyze said traffic models of each first set to deduce a stability state for each first set obtained during each second period;

the analysis means may analyze said traffic models of each first set by comparing each of them to a base traffic model, for example by means of at least one proximity criterion;

the analysis means may determine stability state changes (or stability changes) by comparing stability states associated with the same network element and obtained during at least two successive second periods;

the analysis means may deduce at least certain of said stability states by excluding from their comparison a traffic model of the set that satisfies a selected criterion.

The invention also proposes an optimization system for a communications network including network elements through which passes traffic defined locally by parameter values, which optimization system comprises a processor device of the above kind.

The invention is especially suitable, although not exclusively so, for radio communications networks, in particular cellular (or mobile) networks. It relates generally to any type of communications network, including fixed switched networks (the plain old telephone service (POTS) and public switched telephone networks (PSTN)), cable local area networks (LAN) and wireless local area networks (WLAN).

Other features and advantages of the invention become apparent on reading the following detailed description and examining the appended drawings, in which:

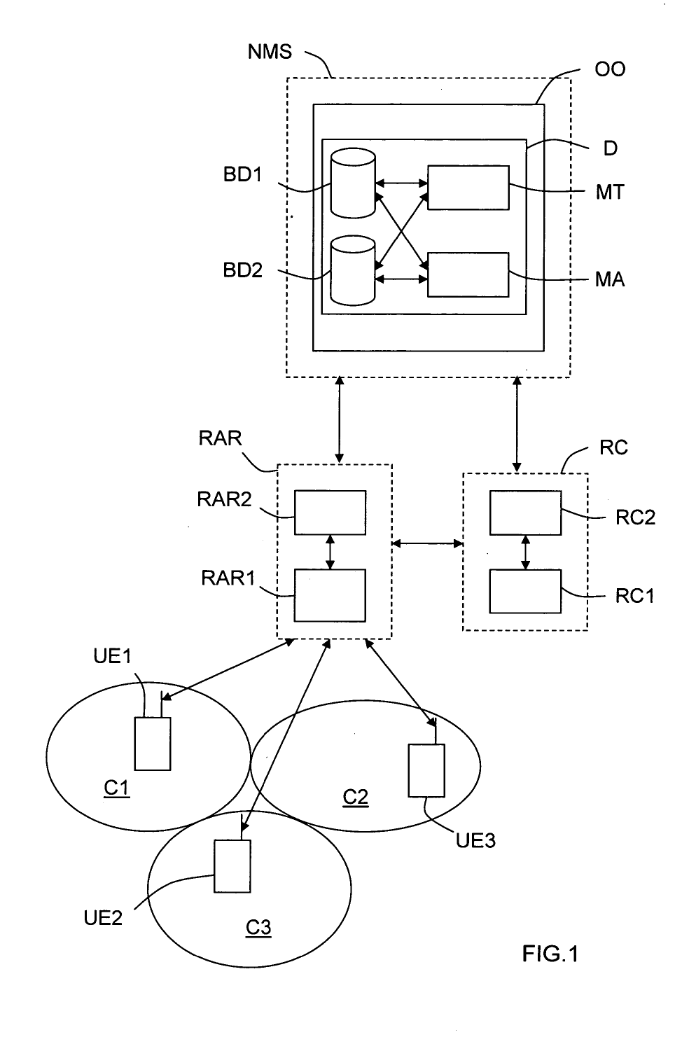

FIG. 1 is a diagram of a cellular communications network equipped with one embodiment of a processor device of the invention;

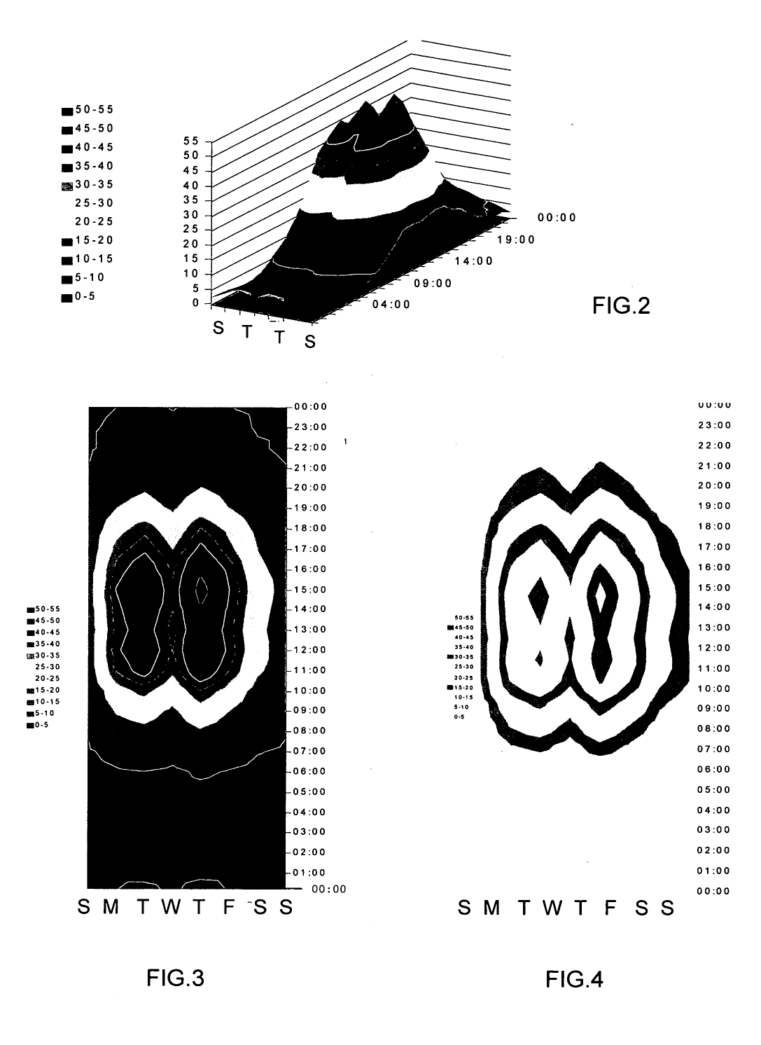

FIG. 2 is a three-dimensional (3D) diagram of the evolution of the traffic at a network element as a function of the day of the week and the time of day;

FIG. 3 is a two-dimensional (2D) diagram showing a simplified form of the traffic evolution of FIG. 2;

FIG. 4 is a 2D diagram showing a simplified form of the traffic evolution of FIG. 3;

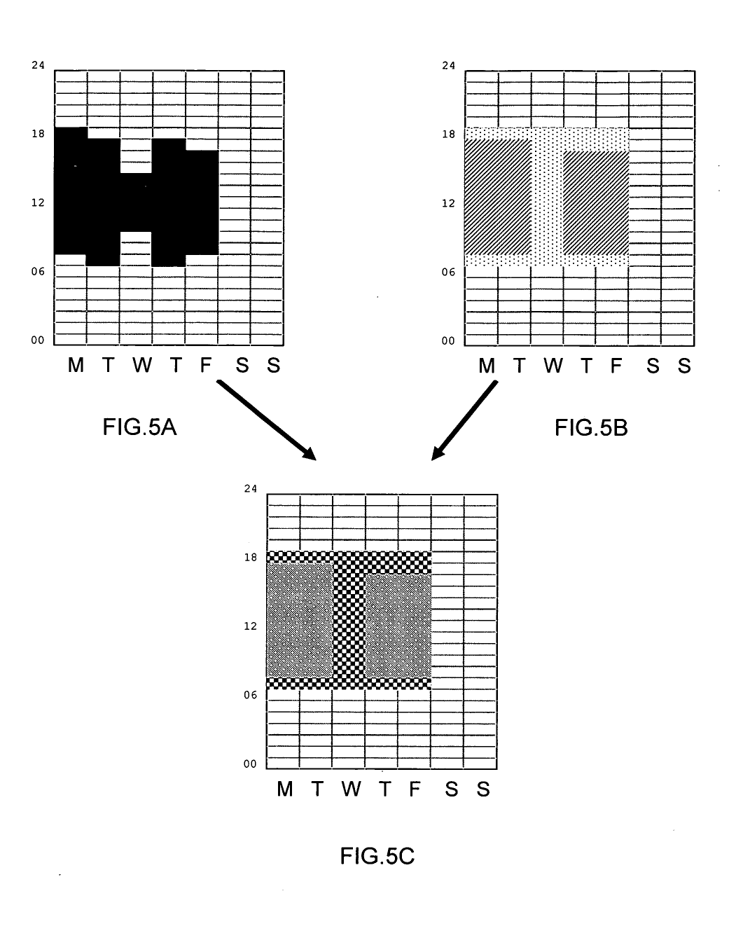

FIGS. 5A to 5C respectively show a 2D traffic model derived from the 2D diagram of FIG. 4, an example of a base traffic model, and the result of comparing the FIG. 5A traffic model with the FIG. 5B base traffic model;

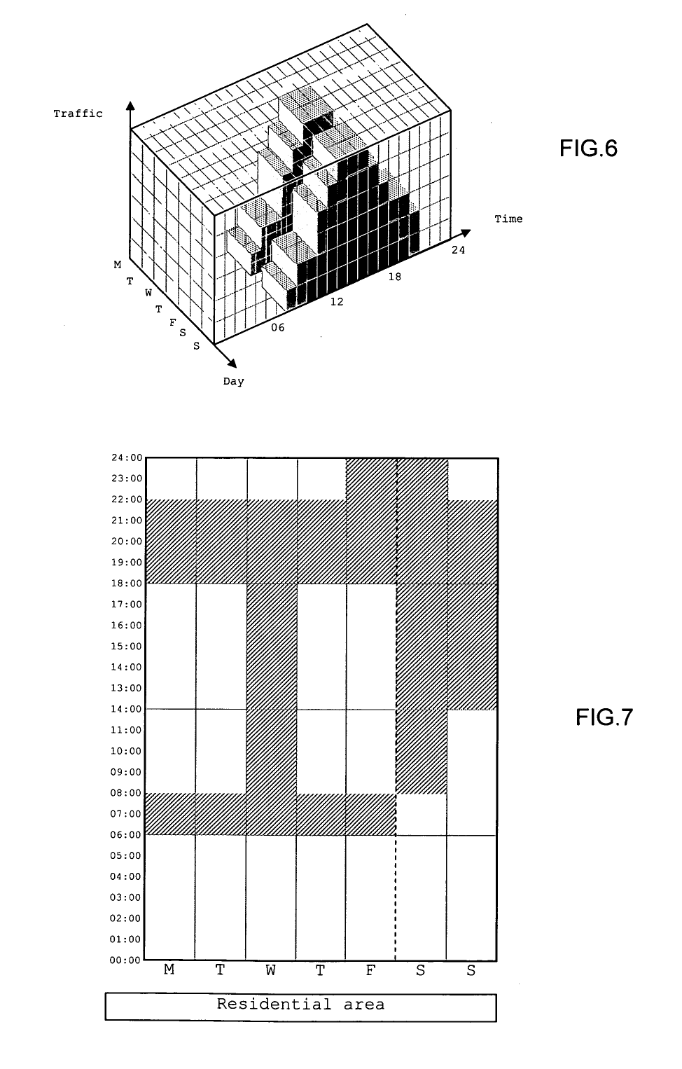

FIG. 6 is a 3D diagram of one example of a 3D traffic model representing the evolution of traffic at a network element as a function of the day of the week and the time of day;

FIG. 7 is a 2D diagram of one example of a base traffic model corresponding to traffic in a residential area as a function of the day of the week and the time of day;

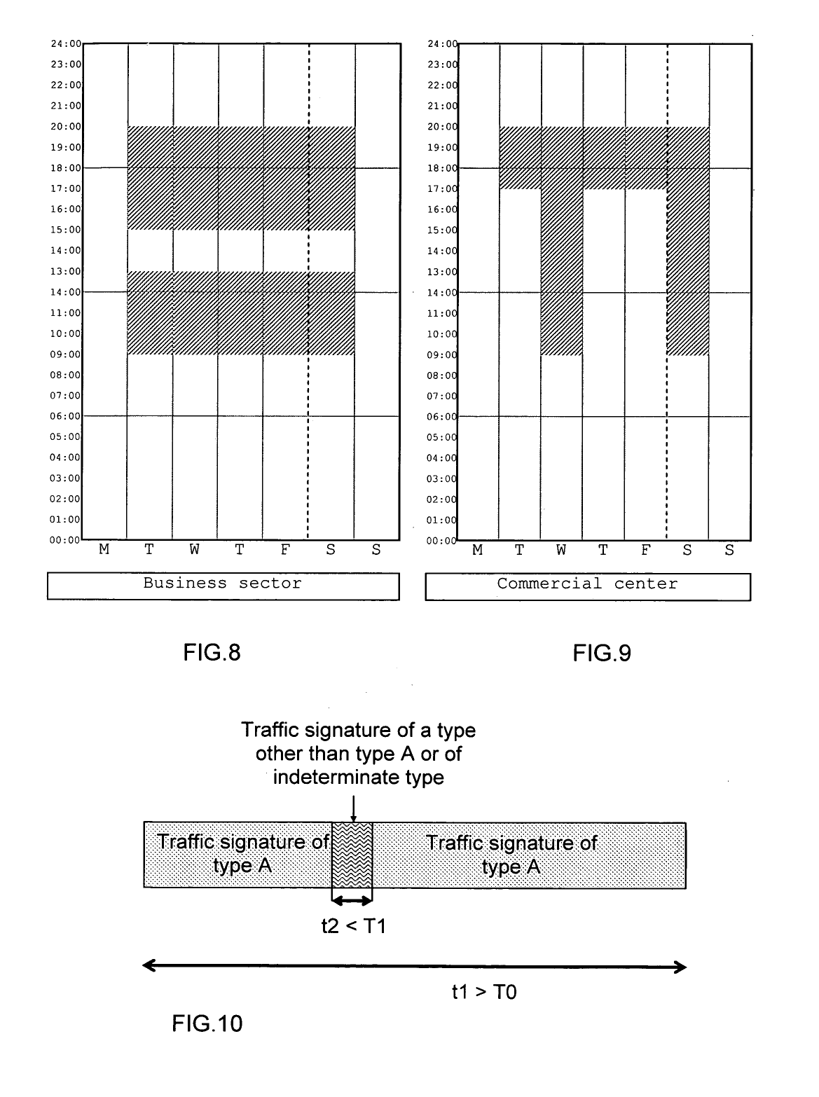

FIG. 8 is a 2D diagram of one example of a base traffic model corresponding to traffic in a business area as a function of the day of the week and the time of day;

FIG. 9 is a 2D diagram showing one example of a base traffic model corresponding to traffic in a commercial centre as a function of the day of the week and the time of day;

FIG. 10 shows a situation leading to the determination of a state of stability;

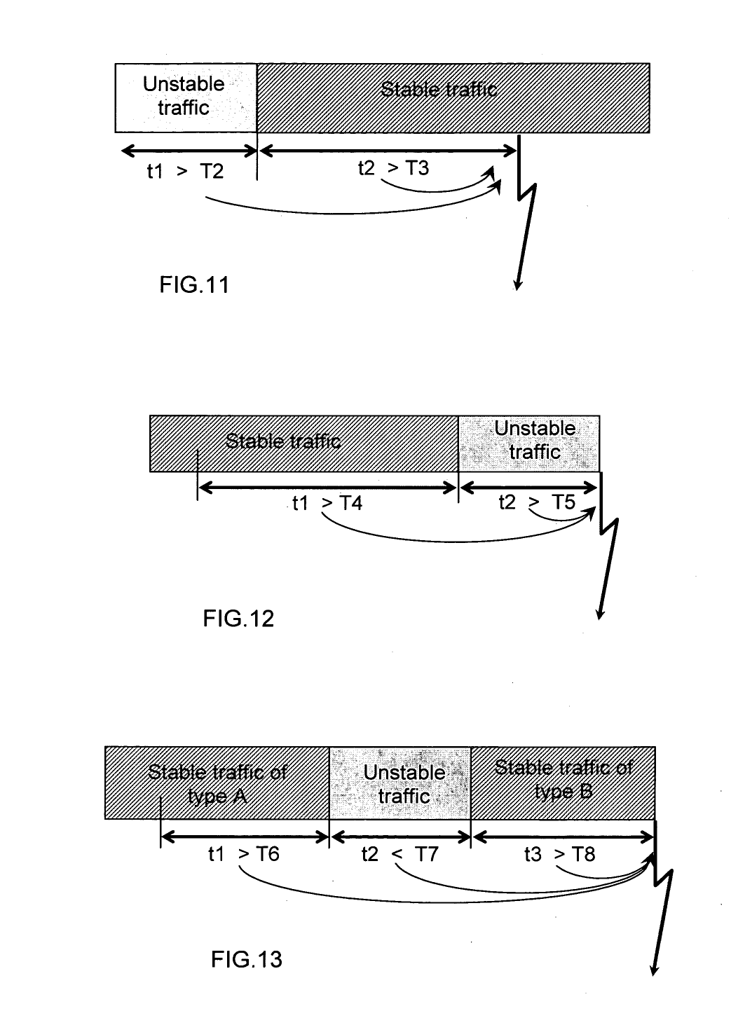

FIG. 11 shows a situation leading to detection of stability;

FIG. 12 shows a situation leading to detection of loss of stability; and

FIG. 13 shows a situation leading to detection of a change of stability.

The appended drawings constitute part of the description of the invention and may, if necessary, contribute to the definition of the invention.

An object of the invention is extensively to optimize the use of communications resources of a communications network.

The communications network considered hereinafter is a cellular (or mobile) radio network, for example a GSM, GPRS/EDGE, or UMTS network. Consequently, the network resources considered hereinafter are radio channels. The invention is suitable for any type of communications network, however, and in particular fixed switched networks (POTS and PSTN), cable local area networks (LAN), and wireless local area networks (WLAN).

A cellular radio network that can use the invention is first described briefly with reference to FIG. 1.

Broadly speaking, but nevertheless in sufficient detail for the invention to be understood, a cellular radio network may be regarded as comprising a switching network (or core network) RC connected to a radio access network RAR (a radio access network is called a UTRAN in a UMTS network and a BSS in a GSM network), in turn connected to a network management system (NMS).

The radio access network RAR includes a set RAR1 of base stations (a base station is called a Node B in a UMTS network or a base transceiver station (BTS) in a GSM network) and radio network controllers or nodes (called radio network controllers (RNC) in a UMTS network or base station controllers (BSC) in a GSM network), which are connected to each other, and an access network manager RAR2 connected to the set RAR1 of base stations. The network management system NMS is additionally connected to the base stations via the radio network controllers.

Each base station (Node B or BTS) is associated with at least one cell Ci covering a radio area in which mobile terminals UEj can set up (or continue) radio connections.

In the present context, the expression “mobile terminal” refers to any mobile or portable communications terminal capable of exchanging data in the form of radio signals either with another terminal or network equipment via their parent network or with its own parent network. The mobile terminals may therefore be mobile telephones, fixed or portable computers, or personal digital assistants (PDA) equipped with a radio communications module.

In the present example, three cells (C1-C3, i=1 to 3) are shown. The suffix i can take any non-zero value, however. Moreover, in the present example, three mobile terminals (UE1-UE3, j=1 to 3) are shown. However, the suffix j can take any non-zero value.

The switching network RC comprises a set RC1 of network equipments connected to the radio network controllers (RNC or BSC) of the set RAR1 of base stations and a switching network manager RC2 connected to the set RC1 of network equipments and to the network management system NMS.

The network management system NMS comprises (or is connected to) an optimization system (or tool) OO for optimizing the use of the communications resources of the (cellular) radio network, for example the RNO® system referred to in the introduction.

The invention proposes a device for processing traffic data D for the optimization system (or tool) OO. In the present non-limiting embodiment the processor device MT is integrated into the optimization system (or tool) OO, but it could be installed in a network equipment or in a dedicated unit connected thereto.

The traffic data processor device D of the invention includes a processor module MT responsible, firstly, for determining for selected elements of the radio network at least one traffic model from successive measured values of at least one parameter representing that traffic, for example the traffic volume (expressed in Erlangs).

In the present context, the expression “traffic model” refers to data representing the evolution of traffic at a network element (referred to hereinafter as the “measured model”). In other words, a measured model constitutes a traffic signature at a network element.

Moreover, in the present context, the expression “network element” refers to any component of the network through which passes traffic defined locally by values of parameters that can be measured or estimated by the network management system NMS. Thus the network element could be a cell Ci, for example, in which mobile terminals UEj can set up or continue calls, or a network equipment, such as a router or a base station.

Any measured model determination technique may be envisaged. For example, the starting point may be data supplied by the network management system NMS and defining a 3D diagram representing the evolution of the traffic at a network element as a function of two variables.

FIG. 2 shows a 3D diagram of the above kind by way of example. It represents the evolution of traffic at a cell Ci as a function of the day of the week and the time of day. Other variables may be envisaged, and in particular the day of the week and the month or the month and the year.

Of course, the diagram may be a 2D diagram, in which case it represents the evolution of the traffic at a network element as a function of only one variable.

Once the processor module MT is in possession of data defining an evolution diagram, it proceeds to determine a measured model. It may use any type of mathematical method for this purpose. In particular, the data of the FIG. 2 evolution diagram may be processed to project that data into a plane, as shown in FIG. 3 (obviously this processing is omitted in the case of a 2D evolution diagram). Then a characteristic simplified shape may be determined within this projection, as shown in FIG. 4. Finally, this characteristic simplified shape may be applied to a grid, as shown in FIG. 5A, to obtain the required measured model. Here each black box of the grid corresponds to traffic exceeding a selected threshold, for example 10 Erlangs per hour (or per quarter-hour), or greater than 1% of the total traffic over a week.

In the example shown in FIG. 5A, the measured model is a 2D model. However, it is possible to determine 3D measured models. In this case, a simplified characteristic shape is determined from the 3D evolution diagram, after which the characteristic simplified shape is written into a space divided into individual bricks in order to determine the 3D measured model.

The processor module MT preferably stores each measured model that it has determined in a first memory (or database) BD1 of the processor device D, in corresponding relationship to an identifier representing the corresponding network element.

The processor module MT is also responsible for comparing the measured models to base traffic models (referred to hereinafter as “base models” or “(traffic) signatures”) each representing a type of traffic, in order to associate a traffic signature with each network element for which a measured traffic model is comparable to the traffic signature.

In the present context, the expression “(measured or base) traffic model” refers to any model representing the evolution of voice and/or data traffic, in telecommunications terms, and/or relating to the manner in which a call associated with traffic progresses, for example the call duration.

Moreover, in the present context, the expression “traffic type” refers to traffic that is characteristic of a geographical area or an environment. For example, base models may be defined respectively corresponding to traffic in residential areas (see FIG. 7), business areas (see FIG. 8) and commercial centers (see FIG. 9).

In the example shown in FIG. 7, which corresponds to traffic in a residential area, note that:

except for Wednesdays and weekends, there is no traffic during working hours, i.e. from approximately 08 h00 to approximately 18h00, Wednesdays frequently corresponding to the presence of one of the parents at home taking care of the children;

the traffic terminates in the evening at about 22 h00, except on Friday and Saturday evenings, where it terminates toward midnight (24 h00);

on Sundays there is virtually no traffic until about 14 h00.

In the example shown in FIG. 8, which corresponds to the traffic in a business area, note that traffic is high from 09 h00 to 13 h00 and then from 15 h00 to 20 h00 on all business days.

In the example shown in FIG. 9, which corresponds to the traffic in a commercial centre, note that traffic is high only between 17 h00 and 20 h00 on Tuesdays through Saturdays, except for Wednesdays and Saturdays, when it is high from 09 h00 to 20 h00.

It is important to note that the base models may vary significantly from one country to another, or even from one region to another, in particular as a function of the climate and/or lifestyles and working styles. These base models are stored in a second memory (or database) BD2 of the processor device MT, for example. They are determined by an expert, for example.

To facilitate comparison, a measured model preferably has the same format as the base model to which it must be compared. This is the case in particular in the example of comparison shown in FIGS. 5A to 5C.

In that example, it is a question of comparing the 2D measured model of a network element, represented by the FIG. 5A grid, to a 2D base model corresponding to a particular traffic type, represented by the FIG. 5B grid. In the FIG. 5B example, a rectangle shaded grey corresponds to an hour of a day during which traffic exceeding a selected threshold is always present, a white dotted rectangle corresponds to an hour of a day during which traffic exceeding the selected threshold may be present, and an empty rectangle corresponds to an hour of a day during which the traffic never exceeds the selected threshold. Here, the base model indicates that:

there is always traffic greater than the selected threshold from 08 h00 to 17 h00 on Mondays and Tuesdays and from 08 h00 to 16 h00 on Thursdays and Fridays;

there is never traffic exceeding the selected threshold from 19 h00 to 06 h00 on any day of the week;

there may be traffic exceeding the selected threshold the rest of the time.

In this example, the FIG. 5A measured model corresponds exactly to the FIG. 5B base model, as is indicated by the comparison result shown in FIG. 5C (the grey rectangles with crosses correspond to the dark rectangles from FIG. 5A that are inscribed in the grey shaded rectangles from FIG. 5B, and the rectangles with black and white checkerboards correspond to the black rectangles of FIG. 5A that are inscribed in the dotted rectangles of FIG. 5B). In other words, the processor module MT here detects that the traffic (modeled in FIG. 5A) that was measured at a network element, for example a cell Ci, corresponds to the type of traffic defined by the base model (shown in FIG. 5B).

In the example shown in FIG. 5B, the base model is a 2D model. However, as shown in FIG. 6, it is possible to determine 3D base models. In the FIG. 6 example, a black brick corresponds to an hour of a day during which there is always traffic exceeding a selected threshold, a dotted grey brick corresponds to an hour of a day during which there may be traffic exceeding the selected threshold, and an empty brick corresponds to a time of a day during which there is never traffic exceeding the selected threshold.

The processor module MT may use any comparison technique (or combination of comparison techniques). For example, it may effect its comparisons using one or more proximity criteria. Proximity criteria include comparing the average distance between an element of a measured model and the corresponding element of a base model to a selected distance threshold. Comparing envelopes may also be cited.

The network operator can preferably configure and modify the comparison criteria. Moreover, the operator may fix the proximity conditions independently of the comparison technique used.

If more than one network element is associated with the same base model (and is therefore subject to the same type of traffic), the processor module MT may be arranged to define a set of objects (or object zone) that groups them together.

In the present context, the term “object” refers to a physical network element, for example a cell, or a logical network element, for example an adjacency relationship defined on the basis of a movement of one cell toward another.

The processor module MT can determine a set of objects by comparing measured models either with one or more base models selected by the operator of the network and stored in the second memory BD2 or with all the base models stored in the second memory BD2.

As a measured model may correspond to a plurality of base models, it is possible for the processor module MT to determine sets of objects in which each object corresponds to a plurality of base models.

The processor module MT determining sets of objects in which the objects do not correspond to any base model or correspond to a plurality of base models may also be envisaged.

Each set of objects determined by the processor module MT is sent to the optimization system OO at the initiative of the operator of said network in order for the latter to use it in the context of a request to optimize the resources of the radio network.

These sets of objects may enable the operator to understand better the behaviors and/or habits of his customers as a function of the areas in which they live and/or the areas in which they work, and consequently to adapt the resources and the quality of service of his network accordingly. They may also enable the operator to concentrate optimization of the resources of his network on a particular type of traffic and on controlling a selected quality of service, using for this purpose all of the (consolidated) quality of service indicators available at the level of the objects constituting the sets of objects and supplied by the network management system NMS.

Furthermore, thanks to the new sets of objects, new optimization criteria can be defined for the optimization system OO.

It is also possible to define a maintenance intervention policy, or to effect any type of cartographic analysis, for example to study the spatial distribution of the various types of traffic models in order to correlate it with other spatial information or to track the temporal and spatial evolution of the base traffic models associated with geographical areas.

The invention also proposes that the temporal evolution of the measured models should be tracked in order to determine the state of stability of the associated traffic within network elements.

To this end, and as shown in FIG. 1, the processor device MT of the invention may also include an analysis module MA which is responsible firstly for collecting in the first memory BD1 measured traffic models associated with at least certain of the network elements and obtained periodically, with a selected first period P1, by the processor module MT. This necessitates that the first memory BD1 store for a sufficiently long time the data that defines the traffic models measured successively for the same network element.

The analysis module MA therefore has periodic access to each of the selected network elements of a first set of measured models, with a selected second period P2 which is a multiple of the first period P1 (P2=n×P1, with n>1). Consequently, the time for which the data of the measured models is stored in the first memory BD1 is at least equal to the second period P2.

The analysis module MA is also responsible for analyzing the traffic models that constitute each first set, in order to deduce from them a state of stability over each second period P2.

For example, the analysis module MA may for this purpose compare the measured models of each first set with each other. Alternatively, it may compare the measured models of each first set with a base model which is stored in the second memory BD2, for example. That base model is the one that in normal operation defines the type of traffic that passes through the network element with which the stability analysis is concerned.

The analysis module MA may use any comparison technique (or combination of comparison techniques). For example, it may effect its comparisons by means of one or more proximity criteria, for example the comparison of the average distance between an element of a measured model and the corresponding element of a base model to a selected distance threshold. Envelope comparison may also be cited.

For example, the analysis module MA may consider that the traffic passing through a selected network element is stable over a second period P2 when the n models measured over that second period P2 satisfy the selected comparison criterion or criteria, for example one or more proximity criteria. If a stability criterion is not satisfied over a second period P2, the traffic of the network element concerned is considered to be unstable over that second period P2.

For example, the analysis module MA may alternatively consider that the traffic passing through a selected network element is stable over a second period P2 when (n-m) models measured over that second period P2 satisfy the selected comparison (and therefore stability) criterion or criteria. The parameter m is strictly less than the parameter n, and for example equal to 1 or 2. In this variant, the analysis module MA may therefore exclude m measured models from an analysis of n measured models of a first set if those m measured models satisfy at least one selected criterion. For example, it may be decided that any measured model that departs by a value exceeding a selected threshold from the corresponding base model, or from the average of the measured models of its first set, may be excluded because it corresponds to abnormal operation.

It may equally be decided to exclude m measured models if the frequency at which they appear is below a selected frequency and/or their duration is less than a selected threshold duration. FIG. 10 shows a situation of this kind by way of example.

To be more precise, in this example, the analysis module MA detects that over a time period t1 a measured model is comparable to a signature of type A, except during a time period t2 during which said measured model is of a type other than A or of an indeterminate type. It then compares t1 to a first threshold T0; if t1 is greater than T0, it then compares t2 to a second threshold T1 (which is preferably very small in comparison to T0); if t2 is less than T1, then the duration ti is considered to be stable.

Here the first threshold T0 represents the minimum period of stability and the second threshold T1 represents the maximum period during which another signature is accepted during a stability phase.

The analysis module MA may also be responsible for monitoring the evolution of the state of stability associated with one or more network elements. To this end, it compares the states of stability associated with the same network element which it has obtained during at least two successive second periods P2, in order to determine any stability state changes.

At least three types of stability state change or stability change may be determined.

A first type of stability state change corresponds to situations in which an unstable state over a time period exceeding a selected first threshold precedes a stable state over a time period exceeding a selected second threshold (which may be equal to the selected first threshold). In these situations, the analysis module MA warns the optimization system OO that the traffic concerned has just become stable after a period of instability. FIG. 11 shows a situation of this kind by way of example.

To be more precise, in this example, the analysis module MA detects that a given traffic is unstable over a time period t1, and then that it becomes stable over a time period t2. It then compares t1 to a third threshold T2 (greater than or equal to the second threshold T1); if t1 is greater than T2, it then compares t2 to a fourth threshold T3 (greater than or equal to the first threshold T0); if t2 is greater than T3, it then considers that the traffic concerned has become stable again.

Here the third threshold T2 represents the minimum period of instability before initiating stability acquisition and the fourth threshold T3 represents the minimum stability period for instigating a stability acquisition.

A second type of stability state change corresponds to situations in which a stable state over a time period exceeding a selected first threshold precedes an unstable state over a time period greater than a selected second threshold (which may be equal to the selected first threshold). In these situations, the analysis module MA warns the optimization system OO that the traffic concerned has just become unstable after a period of stability. FIG. 12 shows a situation of this kind by way of example.

To be more precise, in this example, the analysis module MA detects that a given traffic is stable over a time period t1 and then becomes unstable over a time period t2. It then compares t1 to a fifth threshold T4 (greater than or equal to the first threshold T0); if t1 if greater than T4 it then compares t2 to a sixth threshold T5 (greater than or equal to the second threshold T1); if t2 is greater than T5, it then considers that the traffic concerned has become unstable.

Here the fifth threshold T4 represents the minimum period of stability and the sixth threshold T5 represents the minimum period of instability for determining a loss of stability.

A third type of stability state change or stability change corresponds to situations in which a stable state associated with a type A traffic signature over a time period greater than a selected first threshold precedes another stable state over a time period greater than a selected second threshold (less than the selected first threshold), which itself precedes a new stable state associated with a type B traffic signature over a time period greater than a selected third threshold (which may be equal to the selected first or second threshold). The converse situation is equally possible. In these situations, the analysis module MA warns the optimization system OO that a stability change (i.e. a change of traffic type) has occurred. FIG. 13 shows a situation of this kind by way of example.

To be more precise, in this example, the analysis module MA detects that traffic of type A is stable over a time period t1, then that it becomes unstable over a time period t2, and then that it becomes stable again, but is now associated with type B, over a time period t3. It then compares t1 to a seventh threshold T6 (greater than or equal to the first threshold T0); if t1 is greater than T6, it then compares t2 to an eighth threshold T7 (less than or equal to the third threshold T2 and the sixth threshold T5); if t2 is less than T7 it compares t3 to a ninth threshold T8 (greater than or equal to the first threshold T0); if t3 is greater than T9 it then considers that new traffic of type B that is stable has come about.

It is important to note that the time period t2 may be zero and therefore that a stability change may be determined with no intermediate phase of instability.

Here the seventh threshold T6 represents the minimum period of the old stability before determining a stability change, the eighth threshold T7 represents the maximum period of instability between the old stability and the new stability for determining a stability change, and the ninth threshold T8 represents the minimum period of the new stability before determining a stability change.

The network operator may define an optimization strategy by using certain resources with different levels of expertise as a function of the stability situation detected by the analysis module MA of the processor device MT. For example, standard optimization plans to be applied may be predefined in the event of long-term stability. To define a suitable optimization plan in the event of instabilities, an in-depth analysis of the causes of instability may be necessary.

Moreover, the stability analysis may serve to trigger diagnostic tests, adaptations or any type of cartographic analysis, for example to study the temporal and spatial evolution of the base traffic models associated with geographical areas.

The processor device D of the invention, and in particular its processor module MT and where applicable its analysis module MA, may take the form of electronic circuits, software (or electronic data processing) modules or a combination of circuits and software.

The invention is not limited to the processor device and network optimization system (or tool) embodiments described hereinabove by way of example only, and encompasses all variants that the person skilled in the art might envisage that fall within the scope of the following claims.

1. A device (D) for processing traffic data for a system (OO) for optimizing a communications network including network elements (Ci) through which passes traffic defined locally by parameter values, characterized in that it comprises processor means (MT) arranged: i) to determine for selected elements of said network a traffic model from successive measured values of a parameter representative of said traffic; and ii) to compare the traffic models determined in this way to base traffic models each representative of one type of traffic so as to associate a base traffic model with one of said network elements when a measured traffic model that corresponds to it is comparable to said base traffic model.

2. A device according to claim 1, characterized in that said processor means (MT) are arranged to define sets of objects each grouping network elements associated with a common base traffic model.

3. A device according to claim 2, characterized in that said sets of objects are selected from groups of network elements and movement groups.

4. A device according to claim 1, characterized in that said processor means (MT) are arranged to effect said comparison by means of a proximity criterion.

5. A device according to claim 1, characterized in that said processor means (MT) are arranged to determine said traffic models from successive values of a parameter representative of said traffic as a function of selected dates and selected times on those dates.

6. A device according to claim 5, characterized in that said processor means (MT) are arranged to determine at least certain of said traffic models in a two-dimensional form.

7. A device according to claim 5, characterized in that said processor means (MT) are arranged to determine at least certain of said traffic models in a three-dimensional form.

8. A device according to claim 1, characterized in that it comprises analysis means (MA) arranged: i) to collect traffic models associated with at least certain of said network elements and obtained periodically, with a first selected period, so as to have periodically, with a second period that is a multiple of the first period, a first set of traffic models for each of those network elements; and ii) to analyze said traffic models of each first set to deduce a stability state for each first set obtained during each second period.

9. A device according to claim 8, characterized in that said analysis means (MA) are arranged to analyze said traffic models of each first set by comparing them with each other.

10. A device according to claim 8, characterized in that said analysis means (MA) are arranged to analyze said traffic models of each first set by comparing each of them to a base traffic model.

11. A device according to claim 8, characterized in that said analysis means (MA) are arranged to analyze said traffic models by effecting a comparison and effect said comparison by means of at least one proximity criterion.

12. A device according to claim 8, characterized in that said analysis means (MA) are arranged to determine stability state changes by comparing stability states associated with the same network element obtained during at least two successive second periods.

13. A device according to claim 8, characterized in that said analysis means (MA) are arranged to deduce at least certain of said stability states by excluding from their comparison a traffic model of the set that satisfies a selected criterion.

14. An optimization system (OO) for a communications network including network elements (Ci) through which passes traffic defined locally by parameter values, characterized in that it comprises a processor device (D) according to claim 1.
